(19) United States
(12) Patent Application Publication
(10) Pub. No.: US 2019/0228550 A1
(43) Pub. Date: Jul. 25, 2019

(54) INFORMATION PROCESSING APPARATUS AND COMPUTER-READABLE STORAGE MEDIUM

(71) Applicant: JINS Inc., Gunma (JP)

(72) Inventor: Taiki KOMODA, Tokyo (JP)

(21) Appl. No.: 16/254,628

(22) Filed: Jan. 23, 2019

(30) Foreign Application Priority Data
Jan. 23, 2018 (JP) 2018-009156

(51) Int. Cl. G06T 11/20; G06F 3/01; G09B 29/00

(52) U.S. Cl. CPC G06T 11/206; G09B 29/00; G06F 3/011

(57) ABSTRACT

Provided is a non-transitory computer-readable storage medium storing thereon a program for causing a computer to function as an activity information acquiring section that acquires activity information indicating times during which each of a plurality of types of activities was performed by a user; a quality information acquiring section that acquires quality information indicating a quality of the activity at each timing within the times during which each of the plurality of types of activities was performed; and a graph data generating section that generates graph data showing, in time series, the times during which each of the plurality of types of activities was performed and the quality of the activity at each timing within the times, based on the activity information and the quality information.

The contents of the following Japanese patent application are incorporated herein by reference:

NO. 2018-009156 filed on Jan. 23, 2018.

### BACKGROUND

### 1. Technical Field

The present invention relates to an information processing apparatus and a computer-readable storage medium.

### 2. Related Art

Technology is known for analyzing activities of a user using a glasses device, a wristwatch device, and the like, as shown in Patent Documents 1 and 2, for example.

### Patent Document 1: Japanese Patent Application Publication No. 2017-070602

### Patent Document 2: Japanese Patent Application Publication No. 2010-017602

There is a desire to provide technology enabling easy understanding of the types, times, and qualities of activities of a user performed in one day.

### BRIEF DESCRIPTION OF THE DRAWINGS

FIG. 1 schematically shows an example of an information processing system 10.

FIG. 2 schematically shows an example of an information management table 180.

FIG. 3 schematically shows an example of a display by a smart phone 100.

FIG. 4 schematically shows an example of another display by the smart phone 100.

FIG. 5 schematically shows an example of a functional configuration of a management server 200.

FIG. 6 schematically shows an example of a functional configuration of the smart phone 100.

FIG. 7 schematically shows an example of a functional configuration of a communication terminal 300.

FIG. 8 schematically shows an example of a functional configuration of the smart phone 100.

FIG. 9 schematically shows an example of a hardware configuration of a computer 900 functioning as the smart phone 100.

FIG. 10 schematically shows an example of a hardware configuration of a computer 1000 functioning as the management server 200.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

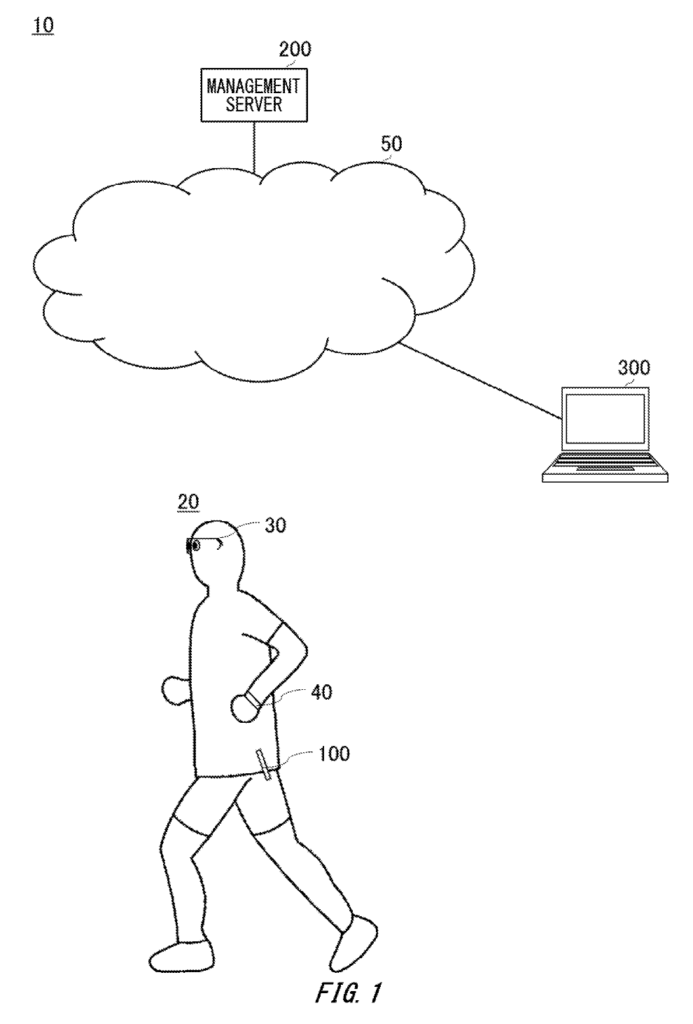

FIG. 1 schematically shows an example of an information processing system 10. The information processing system 10 according to the present embodiment includes a smart phone 100 possessed by a user 20, a glasses device 30 and a wearable device 40 worn by the user 20, and a management server 200.

The glasses device 30 detects various types of biometric data of the user 20. The glasses device 30 includes an electro-oculogram sensor, for example, to detect the eye potential of the user 20. Furthermore, the glasses device 30 includes an acceleration sensor, for example, to detect movement of the head of the user 20. By analyzing the biometric data detected by the glasses device 30, it is possible to derive a degree of focus, a degree of relaxation, and the like of the user 20 from the gazing direction, blinking state, head movement, and the like of the user 20.

The analysis of the biometric data may be performed by the glasses device 30. Also, the analysis of the biometric data may be performed by the smart phone 100. The smart phone 100 may receive the biometric data from the glasses device 30 and perform the analysis. The smart phone 100 and the glasses device 30 may perform short-range wireless communication. The smart phone 100 and the glasses device 30 may adopt any short-range wireless communication method. Examples of this short-range wireless communication include BLUETOOTH (Registered Trademark), Wi-Fi (Registered Trademark), Zigbee (Registered trademark), and the like.

Furthermore, the analysis of the biometric data may be performed by the management server 200. The management server 200 may receive the biometric data from the glasses device 30 via a network 50, and perform the analysis. Alternatively, the management server 200 may receive the biometric data detected by the glasses device 30 from the smart phone 100 via the network 50, and perform the analysis. The network 50 includes the Internet and a cellular telephone network, for example.

The wearable device 40 detects the various types of biometric data of the user 20. For example, the wearable device 40 includes a pedometer, and detects the number of steps of the user 20. As another example, the wearable device 40 includes a heart rate meter, and detects the heart rate of the user 20. By analyzing the biometric data detected by the wearable device 40, it is possible to derive the walking distance, running distance, burned calories, degree of relaxation, sleeping depth, and the like of the user 20. FIG. 1 shows an example of a wristwatch device as an example of the wearable device 40, but the wearable device 40 is not limited to this and may instead be a device attached to another body part of the user 20.

The analysis of the biometric data may be performed by the wearable device 40. Furthermore, the analysis of the biometric data may be performed by the smart phone 100. The smart phone 100 may receive the biometric data from the wearable device 40, and perform the analysis. Furthermore, the analysis of the biometric data may be performed by the management server 200. The management server 200 may receive the biometric data from the wearable device 40 via the network 50, and perform the analysis. Alternatively, the management server 200 may receive the biometric data detected by the wearable device 40 from the smart phone 100 via the network 50, and perform the analysis.

The management server 200 may manage the biometric data and analyzed data, which is the analysis result of the biometric data. The management server 200 may generate information indicating activities of the user 20, using the data being managed. For example, the management server 200 generates activity information indicating the times during which each of a plurality of types of activities was performed by the user 20, and quality information indicating a quality of the activity at each timing during the times when each of the plurality of types of activities was performed.

The management server 200 may transmit the activity information and the quality information to the smart phone 100 via the network 50. The smart phone 100 may generate graph data using the received activity information and quality information, and display this graph data. Furthermore, the management server 200 may transmit the activity information and the quality information to the communication terminal 300 via the network 50. The communication terminal 300 may generate the graph data using the received activity information and quality information, and display this graph data. The smart phone 100 and the communication terminal 300 may each be an example of an information processing apparatus.

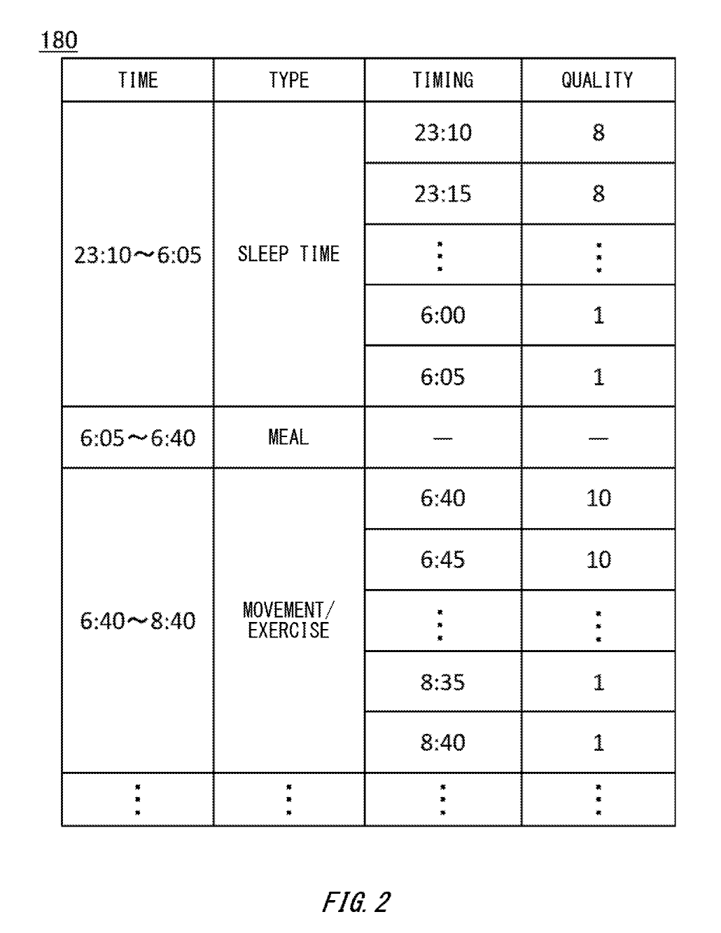

FIG. 2 schematically shows an example of an information management table 180. The management server 200 may register and manage the activity information and the quality information in the information management table 180. In the information management table 180 shown as an example in FIG. 2, an example of the activity information is shown in a case where sleeping is from 23:10 to 6:05, a meal is from 6:05 to 6:40, and movement/exercise is from 6:40 to 8:40.

Furthermore, an example of the quality information is shown in a case where the quality of the sleeping is 8 at 23:10 and 23:15, the quality of the sleeping is 1 at 6:00 and 6:05, the quality of the movement/exercise is 10 at 6:40 and 6:45, and the quality of the movement/exercise is 1 at 8:35 and 8:40. In FIG. 2, an example is shown in which the quality information indicates the quality every 5 minutes, but the quality information is not limited to this and may indicate the quality for any unit of time.

The quality of each of the plurality of types of activities may be set in advance. For example, the quality of sleeping may be the depth of sleeping. Deeper sleep may be indicated by a higher quality. The quality of the movement/exercise may indicate the amount of movement or amount of exercise. A greater amount of movement or a greater amount of exercise may be indicated with a higher quality. Alternatively, the quality of the movement/exercise may be an amount of calories burned. A greater amount of burned calories may be indicated with a higher quality. As another alternative, the quality of the movement/exercise may be exercise intensity. Exercise intensity is METs (metabolic equivalents), for example.

The quality information may be represented according to a quality ranking. FIG. 2 shows an example in which the quality information displays the quality according to a 10-stage ranking from 1 to 10, but the ranking stages are not limited to this and may be arbitrary. Some types of activities do not need to be associated quality information. In the example of FIG. 2, quality information is not registered for the meals.

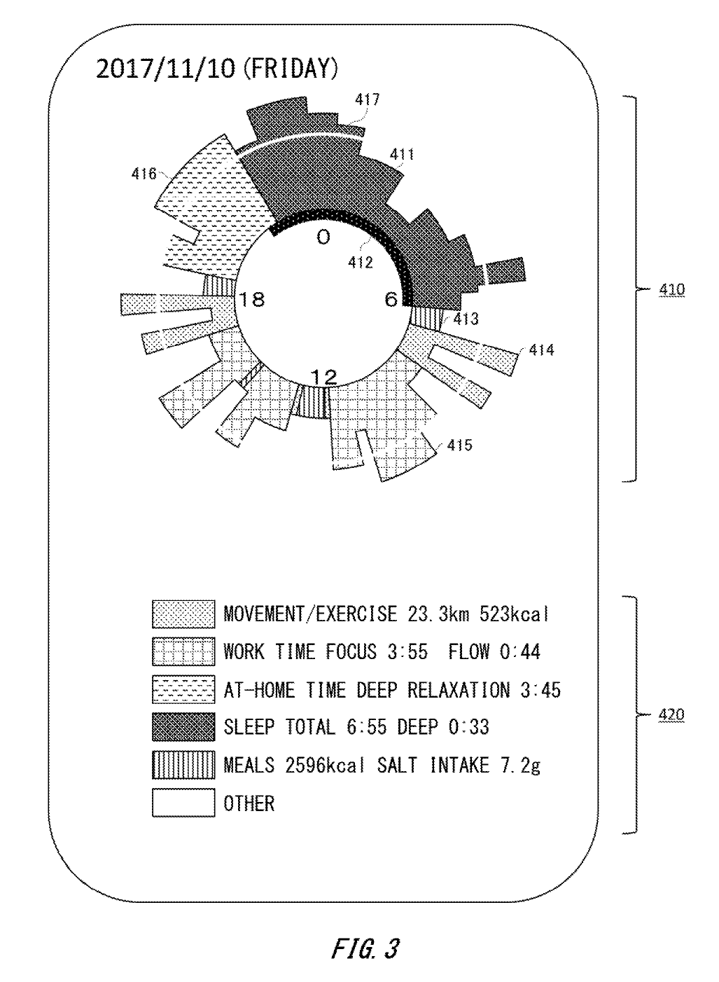

FIG. 3 schematically shows a display example by the smart phone 100. The smart phone 100 may generate graph data indicating the times during which each of the plurality of types of activities was performed and the quality of the activity at each timing during these times, in time series, based on the activity information and the quality information received from the management server 200, and display this graph data. FIG. 3 shows an example in which the graph data includes a circular graph 410 indicating the plurality of types of activities of the user 20 during one day and graph information 420.

In the graph 410, the circumferential direction thereof indicates the flow of time, and the differences in distance away from the center indicate the differences in quality. In FIG. 3, an example is shown in which the activity types are identified using different patterns. However, the identification of the activity types is not limited to this, and this identification may be realized in any way. For example, the activity types may be identified using different colors.

The sleep time 411 indicates the depth of sleep in time series. The previous day sleep time 412 indicates the sleep time of the previous day as seen from the day of the sleeping indicated by the sleep time 411. The meal time 413 indicates the time spent eating. The movement/exercise time 414 indicates the exercise intensity in time series. The work time 415 indicates a degree of focus in time series. The at-home time 416 indicates a degree of relaxation in time series. The line 417 can be arranged anywhere, and may be capable of being switched between being displayed and not being displayed. For example, by arranging the line 417 at a location corresponding to a standard quality, it is possible to easily compare the quality of each activity to the standard quality.

The quality may be indicated by an absolute value. For example, by expressing the depth of sleep as an absolute value in the case of the sleep time 411, it is possible to easily make a comparison and find the difference relative to the depth of sleep on another day or the difference relative to the depth of sleep of another person. Instead, the quality may be indicated by a relative value.

As shown by the example in the graph 410 of FIG. 3, by classifying daily life activities of the user 20 during one day, identifiably displaying amounts of these activities, and expressing the qualities of these activities as distances from the center of a circle, it is possible to express amounts, qualities, and classifications within a single page.

The graph information 420 shows the correspondence relationship between each pattern and the activity type. Furthermore, the graph information 420 includes characters describing each activity. In the example shown in FIG. 3, the graph information 420 shows that, for the movement/exercise, the distance was 23.3 km and the burned calories were 523 kcal. The graph information 420 shows that, for the work time, the time spent concentrating was 3 hours and 55 minutes and the flow, i.e. a so-called hyper-focused state, was 44 minutes. The graph information 420 shows that, for the at-home time, the time spent in a state of deep relaxation was 3 hours and 45 minutes. The graph information 420 shows that, for the sleep time, the total sleep time was 6 hours and 55 minutes and that the deep sleep time was 33 minutes. Furthermore, the graph information 420 shows that, for the meal, the total calories were 2596 kcal and the amount of salt was 7.2 g.

The smart phone 100 may generate the graph data to include information other than the graph 410 and the graph information 420. For example, the smart phone 100 may generate graph data including event data indicating the content and occurrence timing of an event that has occurred for the user 20. As a specific example, the smart phone 100 generates graph data displaying the calories of a meal in association with the location of the meal in the graph 410. As another example, the smart phone 100 generates graph data displaying a blood pressure value of a measurement result at a position corresponding to the timing at which the user 20 underwent a blood pressure measurement in the graph 410. As yet another example, the smart phone 100 generates graph data displaying a body temperature value of a measurement result at a position corresponding to a timing at which the user 20 underwent a body temperature measurement in the graph 410. Furthermore, the smart phone 100 may generate graph data displaying the temperature, weather, heart rate, resting heart rate, and the like in association with the graph 410 and the graph information 420.

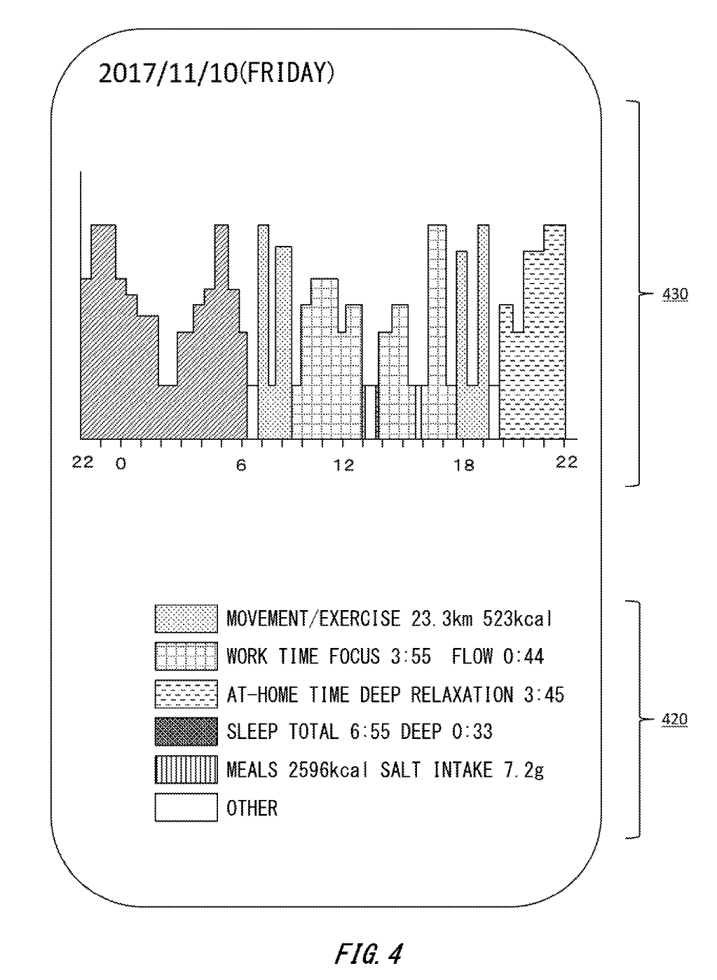

FIG. 4 schematically shows another display example by the smart phone 100. As shown in FIG. 4, the smart phone 100 is not limited to generating graph data with a circular shape, and may generate graph data including a graph 430 with a bar graph shape. Furthermore, the shape of the graph data is not limited to a circular shape and a bar graph shape, and the smart phone 100 may generate graph data including a graph with another shape such as a line graph shape.

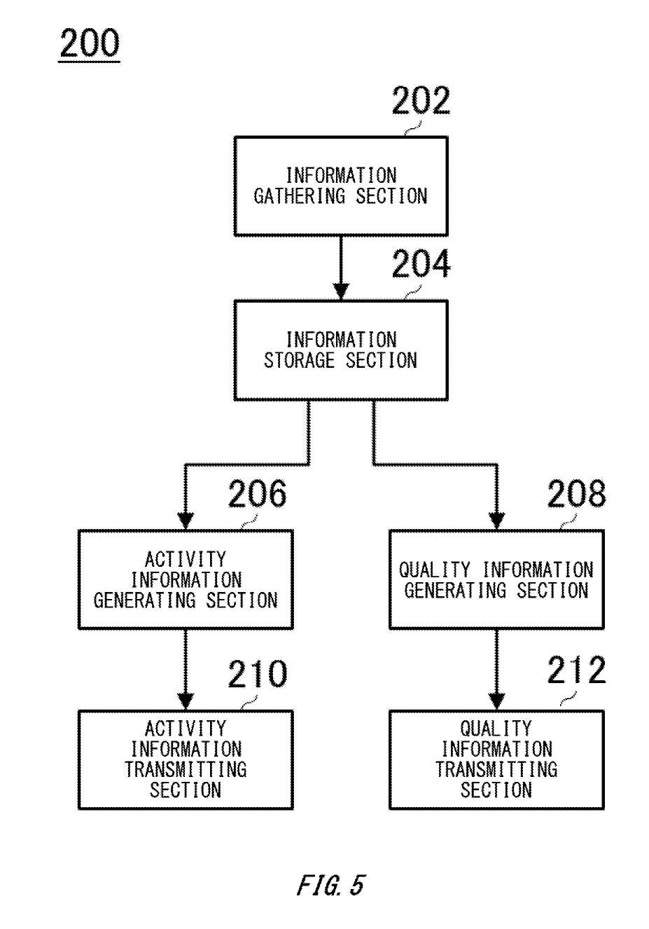

FIG. 5 schematically shows an example of a functional configuration of the management server 200. The management server 200 includes an information gathering section 202, an information storage section 204, an activity information generating section 206, a quality information generating section 208, an activity information transmitting section 210, and a quality information transmitting section 212.

The information gathering section 202 gathers various types of information. For example, the information gathering section 202 gathers the biometric data of the user 20 detected by the glasses device 30. As another example, the information gathering section 202 gathers the analyzed data that is the result obtained by analyzing the biometric data of the user 20 detected by the glasses device 30. The information gathering section 202 may gather the biometric data and the analyzed data from the glasses device 30 and the smart phone 100.

As another example, the information gathering section 202 gathers the biometric data of the user 20 detected by the wearable device 40. As yet another example, the information gathering section 202 gathers the analyzed data that is the result obtained by analyzing the biometric data of the user 20 detected by the wearable device 40. The information gathering section 202 may gather the biometric data and the analyzed data from the wearable device 40 and the smart phone 100.

Furthermore, the information gathering section 202 may gather user-related data relating to the user 20 from the smart phone 100. For example, the information gathering section 202 gathers position information from the smart phone 100. As another example, the information gathering section 202 gathers data relating to meals of the user 20 from an application that manages meals of the user 20 installed on the smart phone 100.

The information gathering section 202 may gather the biometric data of the user 20 from a sensor arranged near the user 20. The sensor arranged near the user 20 is a sensor or the like that detects the sleep of the user 20 arranged in the bedroom of the user 20, for example.

The information storage section 204 stores the data gathered by the information gathering section 202. The information storage section 204 identifies and stores the data of each of a plurality of users 20.

The activity information generating section 206 generates the activity information indicating the time during which each of the plurality of types of activities was performed by the user 20, using the data stored in the information storage section 204. For example, the activity information generating section 206 generates activity information in which a period during which the position information of the user 20 indicates the workplace of the user 20 and the degree of focus of the user 20 is greater than a predetermined threshold value is set to be the work time.

The quality information generating section 208 generates quality information indicating the quality of the activity at each timing in the times during which each of the plurality of types of activities was performed by the user 20, using the data stored in the information storage section 204. For example, the quality information generating section 208 generates quality information indicating the degree of focus every 5 minutes during the work time.

The activity information transmitting section 210 transmits the activity information generated by the activity information generating section 206. For example, the activity information transmitting section 210 transmits the activity information to the smart phone 100 or the communication terminal 300.

The quality information transmitting section 212 transmits the quality information generated by the quality information generating section 208. For example, the quality information transmitting section 212 transmits the quality information to the smart phone 100 or the communication terminal 300.

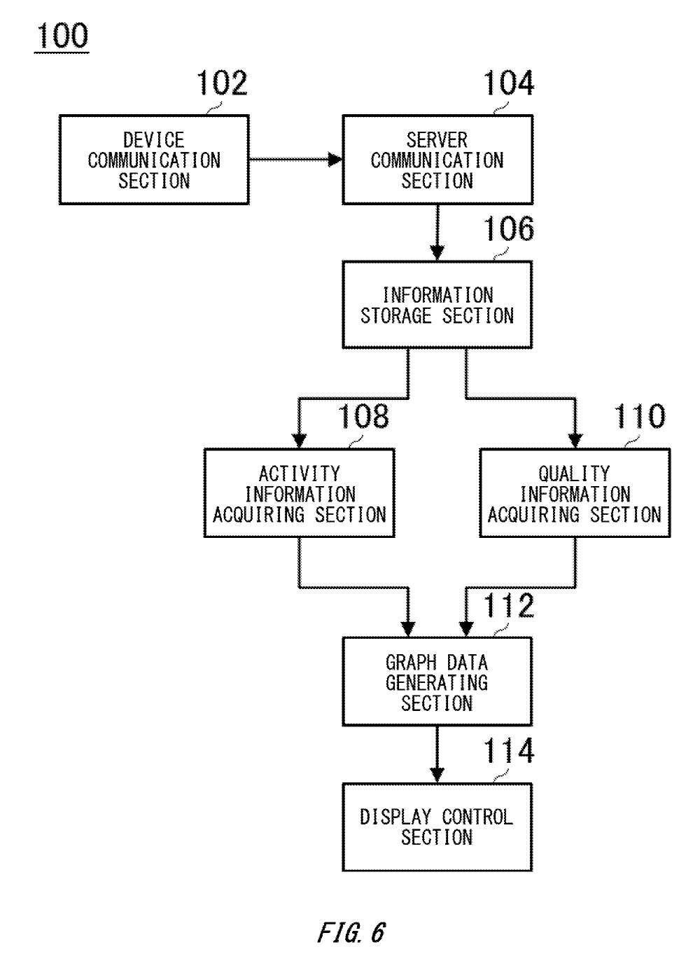

FIG. 6 schematically shows an example of a functional configuration of the smart phone 100. The smart phone 100 includes a device communication section 102, a server communication section 104, an information storage section 106, an activity information acquiring section 108, a quality information acquiring section 110, a graph data generating section 112, and a display control section 114.

The device communication section 102 communicates with the device attached to the body of the user 20. For example, the device communication section 102 communicates with the glasses device 30. As another example, the device communication section 102 communicates with the wearable device 40.

The server communication section 104 communicates with the management server 200. For example, the server communication section 104 transmits to the management server 200 the biometric data and the analyzed data received by the device communication section 102 from the glasses device 30 and the wearable device 40.

Furthermore, the server communication section 104 receives various types of information from the management server 200. For example, the server communication section 104 receives the activity information transmitted by the activity information transmitting section 210. As another example, the server communication section 104 receives the quality information transmitted by the quality information transmitting section 212.

The information storage section 106 stores the information received by the server communication section 104. For example, the information storage section 106 stores the activity information and the quality information. The information storage section 106 may receive from the device communication section 102 and store the biometric data and the analyzed data received from the glasses device 30 and the wearable device 40 by the device communication section 102.

The activity information acquiring section 108 acquires the activity information from the information storage section 106. The quality information acquiring section 110 acquires the quality information from the information storage section 106.

The graph data generating section 112 generates the graph data representing, in time series, the times during which the plurality of types of activities were performed by the user 20 and the quality of the activity at each timing within these times, based on the activity information acquired by the activity information acquiring section 108 and the quality information acquired by the quality information acquiring section 110.

The display control section 114 causes the graph data generated by the graph data generating section 112 to be displayed. For example, the display control section 114 causes the graph data to be displayed in a display of the smart phone 100.

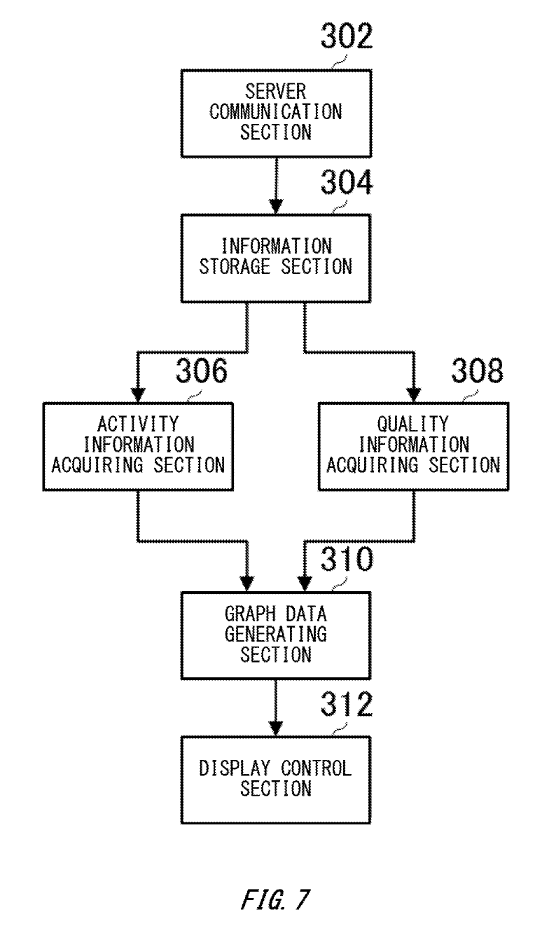

FIG. 7 schematically shows an example of a functional configuration of the communication terminal 300. The communication terminal 300 includes a server communication section 302, an information storage section 304, an activity information acquiring section 306, a quality information acquiring section 308, a graph data generating section 310, and a display control section 312.

The server communication section 302 receives various types of information from the management server 200. For example, the server communication section 302 receives the activity information transmitted by the activity information transmitting section 210. As another example, the server communication section 302 receives the quality information transmitted by the quality information transmitting section 212.

The information storage section 304 stores the information received by the server communication section 302. For example, the information storage section 304 stores the activity information and the quality information.

The activity information acquiring section 306 acquires the activity information from the information storage section 304. The quality information acquiring section 308 acquires the quality information from the information storage section 304.

The graph data generating section 310 generates the graph data representing, in time series, the times during which the plurality of types of activities were performed by the user 20 and the quality of the activity at each timing within these times, based on the activity information acquired by the activity information acquiring section 306 and the quality information acquired by the quality information acquiring section 308.

The display control section 312 causes the graph data generated by the graph data generating section 310 to be displayed. For example, the display control section 312 causes the graph data to be displayed in a display of the communication terminal 300.

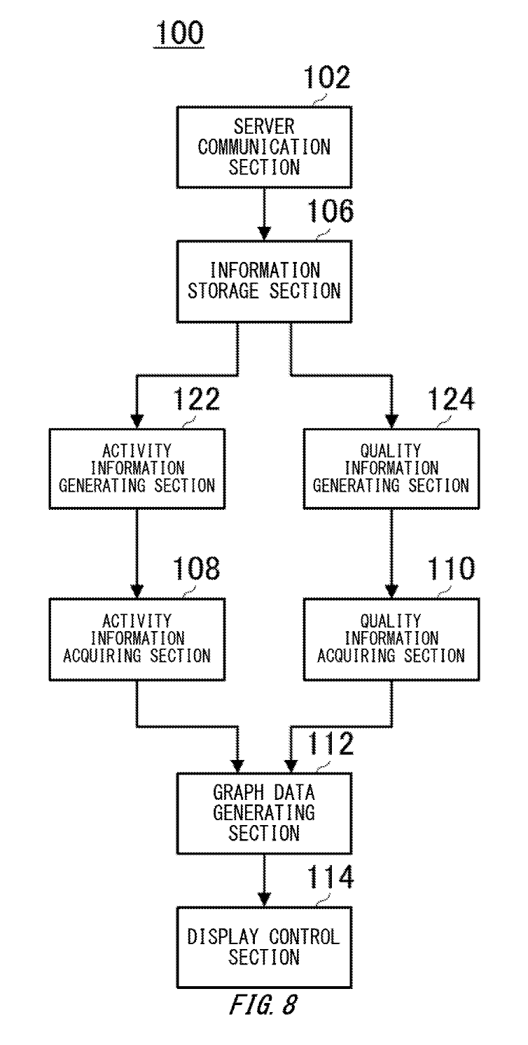

FIG. 8 schematically shows another example of a functional configuration of the smart phone 100. The smart phone 100 includes the device communication section 102, the server communication section 104, the information storage section 106, an activity information generating section 122, a quality information generating section 124, the activity information acquiring section 108, the quality information acquiring section 110, the graph data generating section 112, and the display control section 114.

Here, the description mainly concerns points differing from FIG. 6. The smart phone 100 shown in FIG. 8 generates the activity information and the quality information itself, without going through the management server 200.

The device communication section 102 stores, in the information storage section 106, the biometric data and the analyzed data received from the glasses device 30 and the wearable device 40. The activity information generating section 122 generates the activity information indicating the times during which the plurality of types of activities were performed by the user 20, using the data stored in the information storage section 106. The quality information generating section 124 generates the quality information indicating the quality of the activity at each timing within the times during which the plurality of types of activities were performed by the user 20, using the data stored in the information storage section 106.

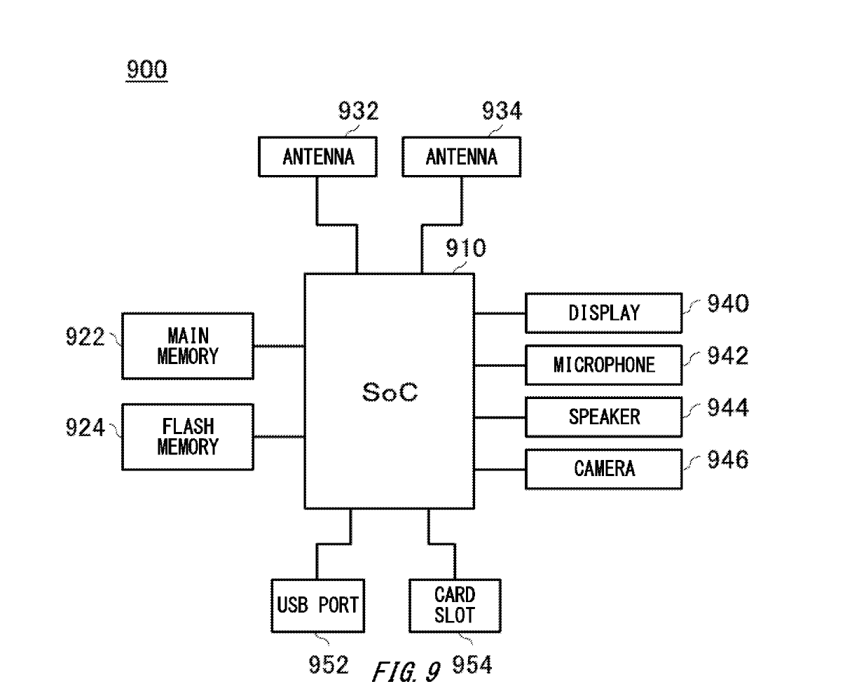

FIG. 9 shows an example of a hardware configuration of a computer 900 functioning as the smart phone 100. The computer 900 according to the present embodiment includes a SoC 910, a main memory 922, a flash memory 924, an antenna 932, an antenna 934, a display 940, a microphone 942, a speaker 944, a camera 946, a USB port 952, and a card slot 954.

The SoC 910 operates based on programs stored in the main memory 922 and the flash memory 924, to control each section. The antenna 932 is a so-called cellular antenna. The antenna 934 is a Wi-Fi antenna. The SoC 910 may realize various communication functions using the antenna 932 and the antenna 934. For example, the SoC 910 may receive the programs used by the SoC 910, using the antenna 932 and the antenna 934, and store these programs in the flash memory 924.

The SoC 910 may realize various display functions using the display 940. The SoC 910 may realize various audio input functions using the microphone 942. The SoC 910 may realize various audio output functions using the speaker 944. The SoC 910 may realize various photography functions using the camera 946.

The USB port 952 realizes a USB connection. The card slot 954 realizes a connection with various cards, such as an SD card. The SoC 910 may receive programs used by the SoC 910 from a memory or device connected to the USB port 952 and a card connected to the card slot 954, and store these programs in the flash memory 924.

The programs installed on the computer 900 that cause the computer 900 to function as the smart phone 100 may act on the SoC 910 or the like to cause the computer 900 to function as each section of the smart phone 100. The information processes recorded in these programs are read by the computer 900 to cause the computer 900 to function as the device communication section 102, the server communication section 104, the information storage section 106, the activity information acquiring section 108, the quality information acquiring section 110, the graph data generating section 112, and the display control section 114, which are specific means realized by the software and various hardware resources described above working together. Furthermore, the information processes recorded in these programs are read by the computer 900 to cause the computer 900 to function as the device communication section 102, the server communication section 104, the information storage section 106, the activity information generating section 122, the quality information generating section 124, the activity information acquiring section 108, the quality information acquiring section 110, the graph data generating section 112, and the display control section 114, which are specific means realized by the software and various hardware resources described above working together. With these specific means, a unique smart phone 100 suitable for an intended use can be constructed by realizing the calculations or computations of information appropriate for the intended use of the computer 900 of the present embodiment.

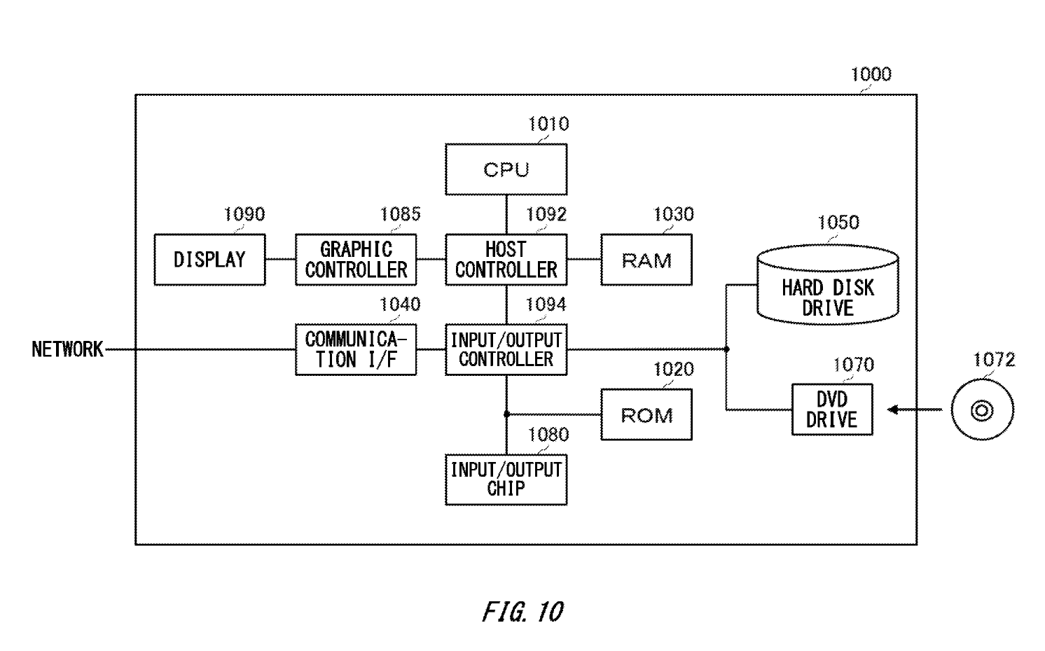

FIG. 10 schematically shows an example of a computer 1000 functioning as the management server 200 or the communication terminal 300. The computer 1000 according to the present embodiment includes a CPU peripheral section having a CPU 1010, a RAM 1030, and a graphic controller 1085, all of which are connected to each other by a host controller 1092, and an input/output section having a ROM 1020, a communication I/F 1040, a hard disk drive 1050, a DVD drive 1070, and a input/output chip 1080, all of which are connected to the host controller 1092 by an input/output controller 1094.

The CPU 1010 operates based on the programs stored in the ROM 1020 and the RAM 1030, to control each section. The graphic controller 1085 acquires image data generated on a frame buffer provided within the RAM 1030 by the CPU 1010 and the like, and displays the image data in the display 1090. Instead, the graphic controller 1085 may include therein a frame buffer that stores the image data generated by the CPU 1010 and the like.

The communication I/F 1040 communicates with another apparatus via a network, using wired or wireless communication. Furthermore, the communication I/F 1040 functions as hardware performing communication. The hard disk drive 1050 stores programs and data used by the CPU 1010. The DVD drive 1070 reads the programs or data from the DVD-ROM 1072, and provides the programs or data to the hard disk drive 1050 via the RAM 1030.

The ROM 1020 stores a boot program executed when the computer 1000 starts up, programs that depend on the hardware of the computer 1000, and the like. The input/output chip 1080 connects various input/output apparatuses to the input/output controller 1094, via a parallel port, a serial port, a keyboard port, a mouse port, and the like, for example.

The programs provided to the hard disk drive 1050 via the RAM 1030 are stored on a recording medium such as the DVD-ROM 1072 or an IC card and provided by an operator. The programs are read from the recording medium, installed in the hard disk drive 1050 via the RAM 1030, and executed by the CPU 1010.

The programs installed on the computer 1000 that cause the computer 1000 to function as the management server 200 may act on the CPU 1010 or the like to cause the computer 1000 to function as each section of the management server 200. The information processes recorded in these programs are read by the computer 1000 to cause the computer 1000 to function as the information gathering section 202, the information storage section 204, the activity information generating section 206, the quality information generating section 208, the activity information transmitting section 210, and the quality information transmitting section 212, which are specific means realized by the software and various hardware resources described above working together. With these specific means, a unique management server 200 suitable for an intended use can be constructed by realizing the calculations or computations of information appropriate for the intended use of the computer 1000 of the present embodiment.

The programs installed on the computer 1000 that cause the computer 1000 to function as the communication terminal 300 may act on the CPU 1010 or the like to cause the computer 1000 to function as each section of the communication terminal 300. The information processes recorded in these programs are read by the computer 1000 to cause the computer 1000 to function as the server communication section 302, the information storage section 304, the activity information acquiring section 306, the quality information acquiring section 308, the graph data generating section 310, and the display control section 312, which are specific means realized by the software and various hardware resources described above working together. With these specific means, a unique communication terminal 300 suitable for an intended use can be constructed by realizing the calculations or computations of information appropriate for the intended use of the computer 1000 of the present embodiment.

In the present embodiment above, an example is described in which the graph data is generated by the smart phone 100 or the communication terminal 300 based on the activity information and the quality information, but the present invention is not limited to this, and the management server 200 may generate the graph data. In this case, the management server 200 is an example of an information processing apparatus.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

10: information processing system, 20: user, 30: glasses device, 40: wearable device, 50: network, 100: smart phone, 102: device communication section, 104: server communication section, 106: information storage section, 108: activity information acquiring section, 110: quality information acquiring section, 112: graph data generating section, 114: display control section, 122: activity information generating section, 124: quality information generating section, 180: information management table, 200: management server, 202: information gathering section, 204: information storage section, 206: activity information generating section, 208: quality information generating section, 210: activity information transmitting section, 212: quality information transmitting section, 300: communication terminal, 302: server communication section, 304: information storage section, 306: activity information acquiring section, 308: quality information acquiring section, 310: graph data generating section, 312: display control section, 410: graph, 411: sleep time, 412: previous day sleep time, 413: meal time, 414: movement/exercise time, 415: work time, 416: at-home time, 417: line, 420: graph information, 430: graph, 900: smart phone, 910: SoC, 922: main memory, 924: flash memory, 932: antenna, 934: antenna, 940: display, 942: microphone, 944: speaker, 946: camera, 952: USB port, 954: card slot, 1000: computer, 1010: CPU, 1020: ROM, 1030: RAM, 1040: communication I/F, 1050: hard disk drive, 1070: DVD drive, 1072: DVD-ROM, 1080: input/output chip, 1085: graphic controller, 1090: display, 1092: host controller, 1094: input/output controller

What is claimed is:

1. A non-transitory computer-readable storage medium storing thereon a program for causing a computer to function as:
an activity information acquiring section that acquires activity information indicating times during which each of a plurality of types of activities was performed by a user;
a quality information acquiring section that acquires quality information indicating a quality of the activity at each timing within the times during which each of the plurality of types of activities was performed; and
a graph data generating section that generates graph data showing, in time series, the times during which each of the plurality of types of activities was performed and the quality of the activity at each timing within the times, based on the activity information and the quality information.

2. The computer-readable storage medium according to claim 1, wherein
the graph data generating section generates the graph data for the plurality of types of activities of the user performed in one day.

3. The computer-readable storage medium according to claim 2, wherein
the graph data generating section generates the graph data with a circular shape showing the plurality of types of activities of the user performed in one day.

4. The computer-readable storage medium according to claim 3, wherein
the graph data generating section generates the graph data with the circular shape in which a circumferential direction thereof indicates a flow of time and a difference in distance from a center thereof indicates a difference in the quality.

5. The computer-readable storage medium according to claim 1, wherein
the graph data generating section generates the graph data in which the types of the plurality of types of activities are distinguished from each other with different colors.

6. The computer-readable storage medium according to claim 1, wherein
the activity information includes at least two of work time, at-home time, movement time, exercise time, meal time, and sleep time.

7. The computer-readable storage medium according to claim 6, wherein
the quality of the work time is a degree of focus of the user.

8. The computer-readable storage medium according to claim 6, wherein
the quality of the at-home time is a degree of relaxation of the user.

9. The computer-readable storage medium according to claim 6, wherein
the quality of the movement time is calories burned due to movement of the user.

10. The computer-readable storage medium according to claim 6, wherein
the quality of the exercise time is calories burned by exercise of the user.

11. The computer-readable storage medium according to claim 6, wherein
the quality of the sleep time is depth of sleep of the user.

12. The computer-readable storage medium according to claim 1, wherein
the graph data generating section generates the graph data including (i) a graph showing, in time series, the times during which each of the plurality of types of activities was performed and the quality of the activity at each timing within the times and (ii) event data showing content and occurrence timing of an event that has occurred for the user.

13. An information processing apparatus comprising:
an activity information acquiring section that acquires activity information indicating times during which each of a plurality of types of activities were performed by a user;
a quality information acquiring section that acquires quality information indicating a quality of the activity at each timing within the times during which each of the plurality of types of activities was performed; and
a graph data generating section that generates graph data showing, in time series, the times during which each of the plurality of types of activities was performed and the quality of the activity at each timing within the times, based on the activity information and the quality information.

14. The information processing apparatus according to claim 13, wherein
the graph data generating section generates the graph data for the plurality of types of activities of the user performed in one day.

15. The information processing apparatus according to claim 14, wherein
the graph data generating section generates the graph data with a circular shape showing the plurality of types of activities of the user performed in one day.

16. The information processing apparatus according to claim 15, wherein
the graph data generating section generates the graph data with the circular shape in which a circumferential direction thereof indicates a flow of time and a difference in distance from a center thereof indicates a difference in the quality.

17. The information processing apparatus according to claim 13, wherein
the graph data generating section generates the graph data in which the types of the plurality of types of activities are distinguished from each other with different colors.

18. The information processing apparatus according to claim 13, wherein
the graph data generating section generates the graph data including (i) a graph showing, in time series, the times during which each of the plurality of types of activities was performed and the quality of the activity at each timing within the times and (ii) event data showing content and occurrence timing of an event that has occurred for the user.
